(19) United States
(12) Patent Application Publication
(10) Pub. No.: US 2007/0274099 A1
(43) Pub. Date: Nov. 29, 2007

(54) LIGHT EXPANDING SYSTEM FOR PRODUCING A PLANAR LIGHT BEAM FROM POINT LIGHT SOURCES

(75) Inventors: Chen-Yu Tai, Sylvania, OH (US); Ping-Kaung Tai, Sylvania, OH (US)

Correspondence Address: MARGER JOHNSON & MCCOLLOM, P.C., 210 SW MORRISON STREET, SUITE 400, PORTLAND, OR, 97204, US

(73) Assignee: CLIO TECHNOLOGIES, INC., Holland, OH (US)

(21) Appl. No.: 11/420,448

(22) Filed: May 25, 2006

(51) Int. Cl. F21V 7/04

(52) U.S. Cl. 362/610

(57) ABSTRACT

A light expanding system for converting light beams generated from point-like light sources into a collimated planar light beam is described herein. The light expanding system is especially suitable for backlighting a liquid crystal flat panel display or other such arrangement requiring backlighting with LEDs as the light source. According to an embodiment of the invention, a system for producing a planar light beam includes a light pipe with microprisms on one of its surfaces, and a beam collector which has microprisms in a plane perpendicular to the microprisms in the light guide. According to another embodiment, the light guide has microprisms on two opposite surfaces, and is capable of multiple mode operation. This multiple mode backlight is capable of illuminating a given active area uniformly with light of different spectrum.

### BACKGROUND OF THE INVENTION

1. Field of the Invention

The invention relates generally to a backlighting system especially suitable for use with liquid crystal displays. In particular, it converts light from point like light sources, such as LEDs into a planar light source. A light pipe assembly in accordance with this invention is suitable for multi-mode operation that can illuminate the display area with light of a different spectrum, and can use LEDs of different colors for display lighting.

2. Description of the Prior Art

Liquid crystal displays are commonly used in portable computer systems, televisions, and other electronic display devices. Most of the large area, high performance LCDs require a source of lighting for operation. Backlighting the LCD has become the most popular source of light in LCD devices. Our earlier invention, described in U.S. Pat. Nos. 5,359,691; 5,390,276 and 5,854,872, provides a very efficient backlighting and can also provide collimated backlighting. Our earlier inventions, described in U.S. Pat. Nos. 5,506,929; 5,668,913 and 5,835,661, disclose methods of converting a light beam generated from a point-like light source into a collimated linear or planar light beam.

The need exists, however, for utilizing back-lighting systems with increasing brightness. The backlight systems described in applicants' earlier inventions that convert light beam from point-like light sources, such as LEDs use only a small number of light sources, and therefore cannot provide adequate brightness for certain large area lighting. Specifically, a backlighting system made with the earlier technology is not suitable for sunlight-readable displays. Although these earlier patents use LEDs of different colors to provide color uniform lighting is reported, it requires multiply stacked light pipes.

Accordingly, the need exists for back-lighting systems that address the drawbacks of the prior art.

### SUMMARY OF THE INVENTION

In an embodiment of this invention, a method of using only one light pipe to mix light coming from light sources of different color, such as red, green and blue LEDs, to achieve color uniform lighting, is disclosed. In another embodiment of this invention, a multi-mode operation backlight is achieved with the use of a single light pipe to have independently controlled light beams entering from two edges of the light guide. The invented lighting system in this embodiment is capable of illuminating a given area uniformly with light of different spectrum but similar angular distribution.

According to the invention, a light expanding system is used to convert light generated from point-like light sources into a planar light beam. The planar light beam can be collimated in one or more dimensions. As compared to conventional lens and mirror collimating systems, the system according to the invention has a reduced volume. The lighting system in this invention is capable of illuminating a given area with light of different spectrum, but similar angular distribution. It can therefore achieve multi-mode operation.

According to one embodiment of the invention, a system for producing collimated light from divergent light beams from multiple point-like light sources includes: i) a light pipe having first, second, and third surfaces, wherein the first and second surfaces are substantially perpendicular, and the third surface is opposite the second surface; ii) a beam collector positioned between the point-like light sources and the first surface of the light pipe for directing light from the point-like light sources into the light pipe in a predetermined way; and iii) a plurality of microprisms positioned adjacent to the second surface of the light pipe. Each of the microprisms has a base surface that is immediately adjacent and substantially parallel to the second surface of the light pipe, and a light reflecting surface shaped so that light entering the light pipe and contacting the light reflecting surface is reflected away from the microprisms being collimated to a predetermined degree. The system according to this embodiment of the invention produces a planar beam.

According to another embodiment of the invention, a system as described immediately above further includes a prismatic, or holographic, diffuser film which changes the propagation direction of light beams transmitting through this film. This diffuser film expands the images of the point light sources, and therefore improves the uniformity of the backlight system. In this embodiment, this prismatic, or holographic, diffuser is placed between the beam collector and the light guide.

According to yet another embodiment of the invention, a system includes structure as described immediately above, but with the prismatic, or holographic, diffuser located between the light source and the beam collector.

According to yet another embodiment of the invention, a system includes structure as described immediately above, but with the prismatic, or holographic, diffuser located on top of the third surface of the light guide.

According to yet another embodiment of the invention, a system includes structure as described in the first embodiment, but with a plurality of microprisms positioned immediately adjacent to the third surface. The axis of the microprisms is essentially perpendicular to that of the microprisms on the second surface. Adding the prisms to the third surface of the light pipe allows multi-mode operation of the backlight with LEDs.

The lighting systems according to the embodiments of inventions discussed above produces a planar light beam that can be used in devices such as liquid crystal displays (LCDs), automobile meters, road signs, and other applications that require uniform lighting from point-like light sources.

The foregoing and other objects, features and advantages of the invention will become more readily apparent from the following detailed description of a preferred embodiment of the invention that proceeds with reference to the accompanying drawings.

### BRIEF DESCRIPTION OF THE DRAWINGS

FIG. 1A is a perspective view of a conventional light expanding system that is configured with microprisms to convert a light beam from a point-like light source into a collimated linear light source.

FIG. 1B is a perspective view of a light expanding system configured according to a first embodiment of the invention, incorporating a plurality of single illuminations source systems and using microprisms to convert a light beam from the point-like light source into a collimated linear light source to form a planar light beam.

FIG. 1C is a perspective view of an alternate configuration of the light expanding system of FIG. 1B using microprisms within a single light pipe to convert light beams from several point-like light sources into a collimated planar light source.

FIG. 1D is a perspective view of another alternate configuration to the light expanding system of FIG. 1B using a single light collector and single light pipe with microprisms to convert light beams from several point-like light sources into a collimated planar light source.

FIG. 2A is a perspective view of a prismatic diffuser for use with a light expanding system according to methods known in the prior art.

FIG. 2B is a sectional view with cross-sectional components shown of a light expanding system according to another embodiment with a prismatic diffuser placed between the light collector and the light pipe.

FIG. 3A is a cross-sectional view, taken through a section in the y-z plane of a conventional light guide, illustrating the path of light beams from three LEDs entering the light guide.

FIG. 3B is a cross-sectional view, taken through a section in the x-z plane, of light beams from a LED entering a prismatic diffuser.

FIG. 3C is a cross-sectional view, taken through a section in the y-z plane of a light expanding system configured according to a preferred embodiment of the invention, illustrating light beams from one of the three LEDs passing through a prismatic diffuser, and entering a light guide.

FIG. 3D is a cross-sectional view, taken through a section in the x-z plane of a light expanding system configured according to a preferred embodiment of the invention, illustrating light beams from one of three LEDs entering a light guide with a prismatic structure on the light entering surface of the light guide.

FIG. 4A is a perspective view of a light expanding system according to the present invention with a prismatic diffuser placed between the light source and the light collector.

FIG. 4B is a perspective view of a light expanding system of the present invention with a prismatic diffuser placed on the light entering surface of the light collector, which is made of a light transmitting material.

FIG. 4C is a perspective view of a light expanding system of the present invention with the light collector composed of two sections.

FIG. 4D is a perspective view of a light expanding system of the present invention with the light collector designed for using side emitting LEDs.

FIG. 4E is a perspective view of the light expanding system in an alternate embodiment of the present invention with the light collector formed as an integral part of the light guide.

FIG. 5A is a perspective view of a dual mode light expanding system of the present invention using microprisms to convert light beams from several point-like light sources, located on two adjacent surface of the light pipe into a collimated planar light source.

FIG. 5B is a perspective view of an alternative embodiment of a dual mode light expanding system having a color filter placed between one of the light sources and the light pipe.

FIG. 6A is a side-elevation view of using a prism to have the point light sources and the light collector located underneath the lighting light pipe.

FIG. 6B is a side-elevation view of an alternate arrangement of the invention to FIG. 6A that uses two prisms to have the point light sources located underneath the lighting light pipe.

FIG. 6C is a side-elevation view of another alternate arrangement to FIG. 6A that uses two prism, each becomes an integral part of the light pipe and the light collector respectively, to have the point light sources located underneath the lighting light pipe.

FIG. 6D is a side-elevation view of yet another alternate arrangement to FIG. 6A that uses a prism to have the point light sources located underneath the lighting light pipe.

FIG. 6E is a side-elevation view of still another arrangement to FIG. 6A that uses a prism, which is an integral part of the light pipe, to have the point light sources located underneath the lighting light pipe.

FIG. 6F is a side-elevation view of still yet another arrangement to FIG. 6A that uses a prism, which is an integral part of the light collector, to have the point light sources located underneath the lighting light pipe.

FIG. 7 is a perspective view of a conventional light expanding system with a prismatic diffuser placed on top of the light pipe with a multiple LED backlight.

FIG. 8A is a perspective view of a backlight configured according to the present invention with a viewing area expanding diffuser plate on top of the light pipe.

FIG. 8B is a partial sectional view, taken through a section in the x-y plane of the backlight of FIG. 8A, with a viewing area expanding diffuser plate placed on top of the light pipe.

### DETAILED DESCRIPTION

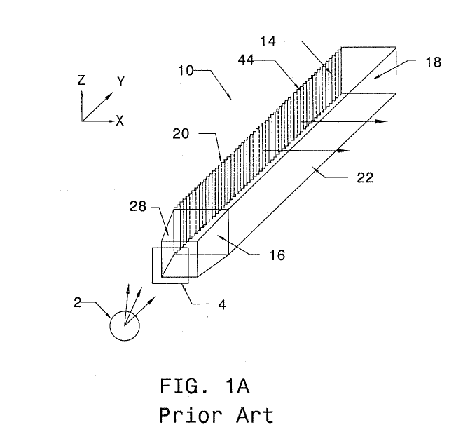

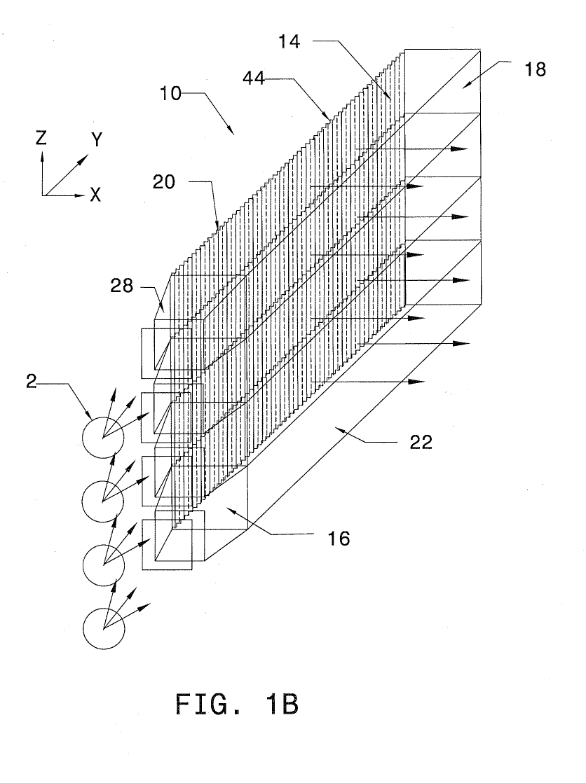

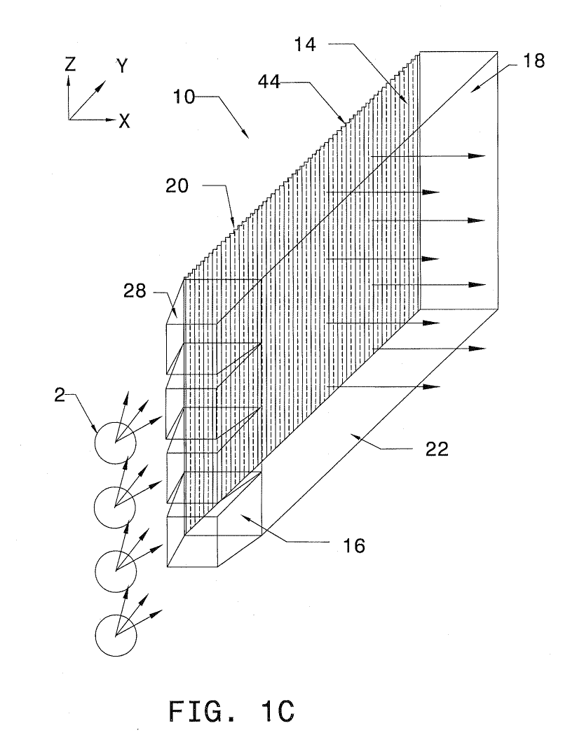

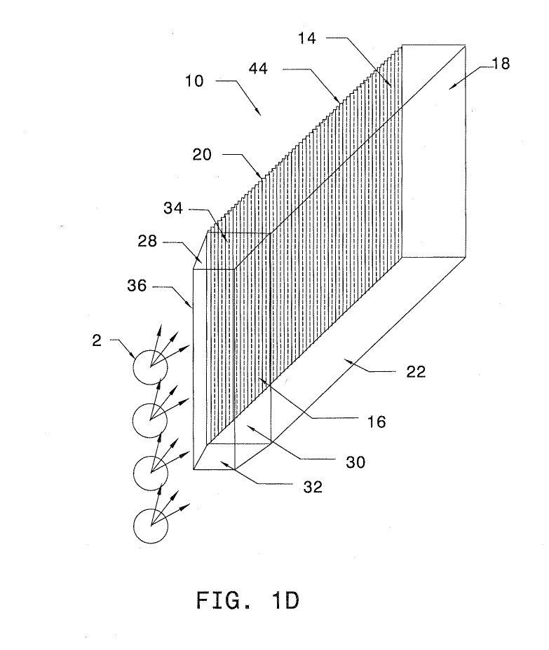

Turning now to the drawings, wherein like components are designed by like reference numerals throughout the various figures, attention is first directed to FIG. 1A which shows a lighting system converting light output from a point-like light source 2 into a linear light beam. This light expanding system 10, discussed in detail in U.S. Pat. No. 5,506,929, includes a beam collector 28 and a beam expanding light pipe 14. A light filter 4, which can be a color filter, or heat filter, is placed between the light source 2 and the light expanding system 10. The filter 4, however, is not required for the operation of the light expanding system 10. A plurality of microprisms 44 are positioned immediately adjacent to a reflecting surface 20 of the beam expanding light pipe 14. Light that enters the beam expanding light pipe 14, through the entering surface 16 of the beam expanding light pipe 14, is directed by the microprisms 44, so that the light exits the beam expanding light pipe 14 at an emission surface 22 that is opposite the reflecting surface 20. The microprisms 44 also collimate the light in a predetermined way. The end surface 18 of the beam expanding light pipe 14, opposing the entry surface 16 is coated with a high reflecting material that reflects light back towards the entry surface 16.

Attention is now directed to FIG. 1B which shows several units of the lighting systems 10, showing in FIG. 1A, are placed sided by side to convert light beams from several point like light sources 2, such as LEDs, into a planar light source. FIG. 1C further shows that the separate light pipes 14 can be replaced by a single light pipe 14 to convert light from several point like light sources 2 into a planar light source. FIG. 1D shows that the separate light collectors 28 in FIG. 1C can also be combined to a single light collector 28. The lighting system, showing in 1C and 1D are suitable to produce collimated planar light beams with sufficient brightness for large LCDs. The light collector 28 can be made of a solid light transparent material, such as acrylic or glass, or simply a space of air with four light reflecting walls 30, 32, 34 and 36.

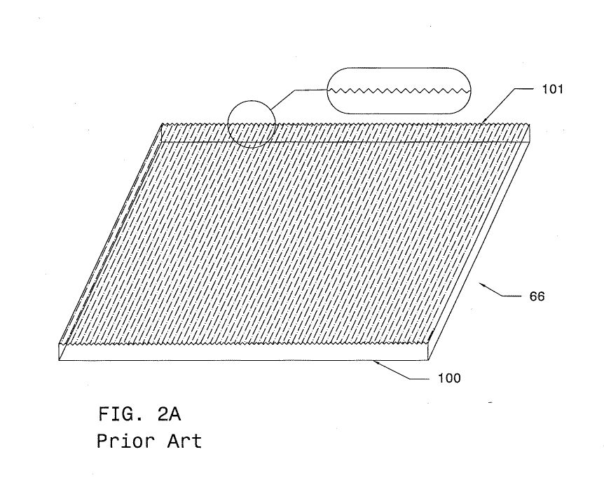

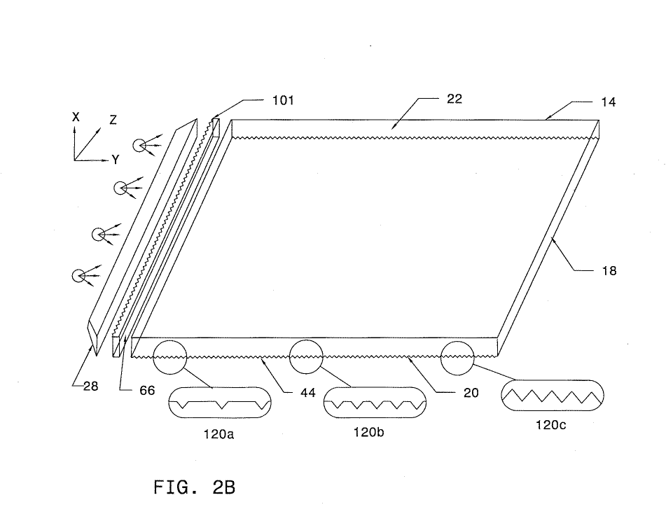

Attention is now directed to FIG. 2A, which shows a prismatic diffuser 66, for use with a light expanding system according to the earlier invention U.S. Pat. No. 5,506,929, U.S. Pat. No. 5,835,661, U.S. Pat. No. 5,668,913, and U.S. Pat. No. 5,926,601. The prismatic diffuser can be used to change the propagation direction and divergent angle of a light beam that is output from the light expanding system. The prismatic diffuser 66 has a light input surface 100 and a light output surface 101. The prismatic diffuser 66 in FIG. 2A has a prismatic surface 101 and a flat surface 100. A detailed description of the prismatic diffuser film is given in U.S. Pat. No. 5,506,929, U.S. Pat. No. 5,835,661, and U.S. Pat. No. 5,668,913. The method of using a prismatic film to increase the divergent angle, or change the propagation direction, of the light beam entering a light pipe is claimed in the claims of U.S. Pat. No. 5,668,913. With light propagating through the film 66, the microprisms in this film may also be called microlenses. Similar structure in the light pipe is called microprisms because they reflect light.

FIG. 2B shows a piece of the prismatic diffuser film 66 placed between the light collector 28 and the light pipe 14. Several point like light sources, instead of one, are used in the light expanding system. In FIG. 2B, the prismatic surface 101, instead of the smooth surface 100, of the prismatic diffuser 66 is now the light entering surface for the diffuser 66. It is understood that other configurations of microstructures, such as structures of microgrooves, or microstructure created as a hologram, can also be used to replace the microprisms in the prismatic surface 101.

As shown in FIG. 2B, the density of the microprisms 44 changes with respect to the distance from the light entrance side surfaces 16 to provide uniformity backlight. In this particular sample of the embodiment, the side surface 18 opposite to the light entrance side surface 16 are tilted by a small angle, approximately 5 degree towards the bottom surface 20 as is illuminated in the drawing. These tilted surfaces have specular reflective coatings. Light beams entering the light pipe with propagation direction parallel to the bottom will be reflected towards the reflecting microprisms 44, and will therefore enhance the efficiency of this backlight system 10.

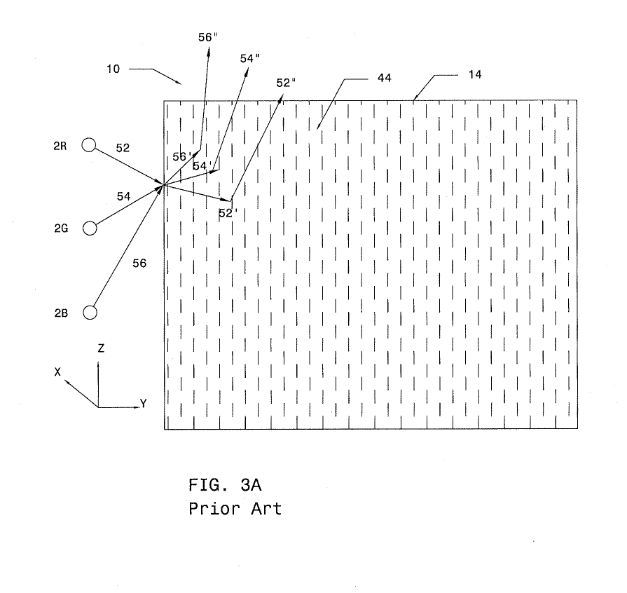

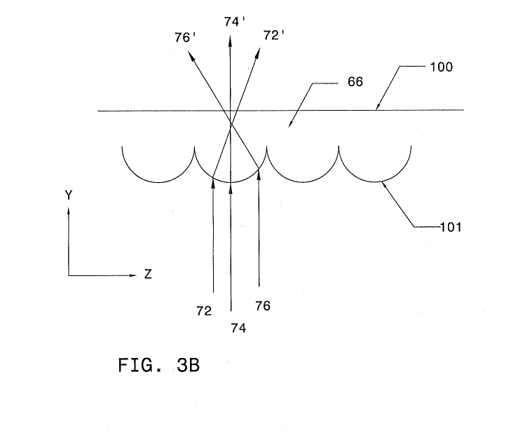

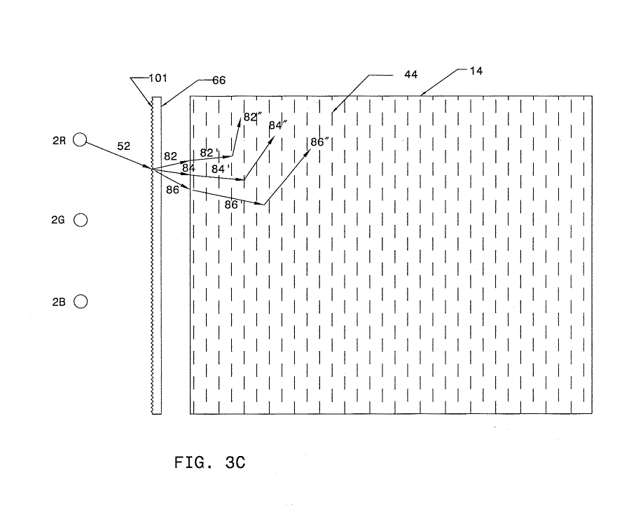

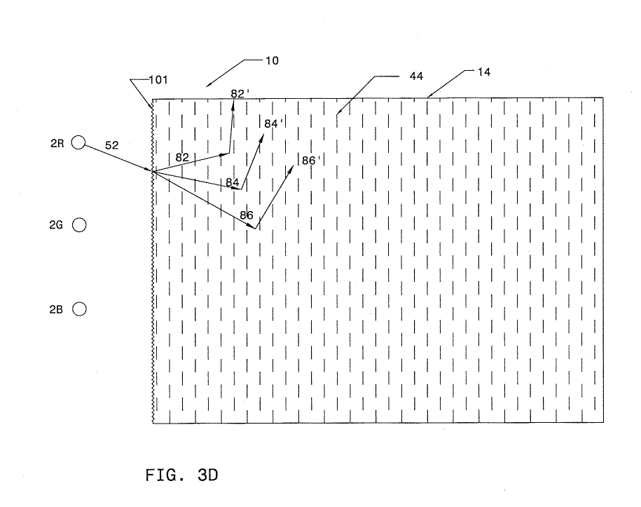

Attention is now directed to FIG. 3A, which shows propagation of light from three LEDs, 2R, 2G, and 2B in the light pipe. In this drawing LED 2R has output light of red color, LED 2G has output light of green color, and LED 2B has output light of blue color. Without any diffuser, light beams from the three LEDs, labeled as beam 52, 54, and 56, will have their propagation direction changed, and will propagate as light beam 52′, 54′ and 56′ respectively inside the light pipe 14. Since the light pipe 14 is based on total reflection from microprisms 44 to send light out, images of the three LEDs 2R, 2G and 2B, will be observed by the viewer. With light beams 52″, 54″, 56″, from the LEDs of different color, red, green and blue, the viewer will observe non-uniformity in color distribution with respect to the viewer's viewing angle. This backlight system 10 is therefore not suitable for display backlight since light from light sources of different color are not well mixed.

FIG. 3B shows propagation of parallel light beams 72, 74 and 76 through a prismatic diffuser 66. As shown in FIG. 3B, and described in U.S. Pat. No. 5,506,929, U.S. Pat. No. 5,835,661, and U.S. Pat. No. 5,668,913, the prismatic film 66 will increase the divergent angle of light beams entering the prismatic diffuser 72, 74, and 76 to light beams 72′, 74′, 76′, of a wider divergent angle in the direction perpendicular to the axis of the micro-prisms, after the beams pass through the prismatic film 66. As shown in FIG. 3C, placing the prismatic film 66 between the light sources and the light pipe will expand a light beam 52 from the light sources, such as 2R, to multiple beams, shown as 82, 84 and 86, of different divergent angles. The beams entering the light pipe 14 and reflected out by the microprisms 44, shown as beams 82′, 84′ and 86′, and 82″, 84″ and 86″ respectively, will therefore give an “expanded” image of the light source 2R. If the microprism in the prismatic diffuser has a curved surface, a single light beam will be expanded into a band of light beam. With light beams from each light source 2R, 2G, 2B being expanded by the prismatic diffuser 66, light beams mixing in the light pipe 14 will be enhanced. It will therefore result in a significant improvement in the uniformity of color in the backlight, and will make it suitable for display backlighting. It should also be pointed out that, even with LEDs of the same color used in a backlight, adding a prismatic film between the light source and the light pipe will still expand the images of the point-like light sources, and therefore removes hot spots in certain viewing angle. Adding a prismatic diffuser to the backlight system will therefore result in significant improvement in the backlight uniformity.

FIG. 3D showed an embodiment of this invention where the prismatic diffuser is attached directly to the light entrance surface of the light pipe, and becomes an integral part of the light guide. The diffusing microprisms 101 will still enhances the mixing of light beams from different point-like light sources under this arrangement. With the prismatic diffuser an integral part of the light guide 14, the backlight system 10 will have two material/air interfaces eliminated, and will therefore result in an improved in the backlight efficiency. Losses by light reflection at the two material/air interfaces are now eliminated.

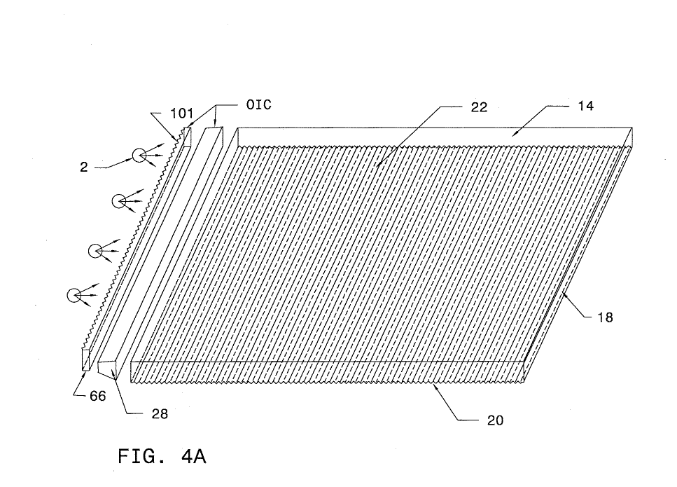

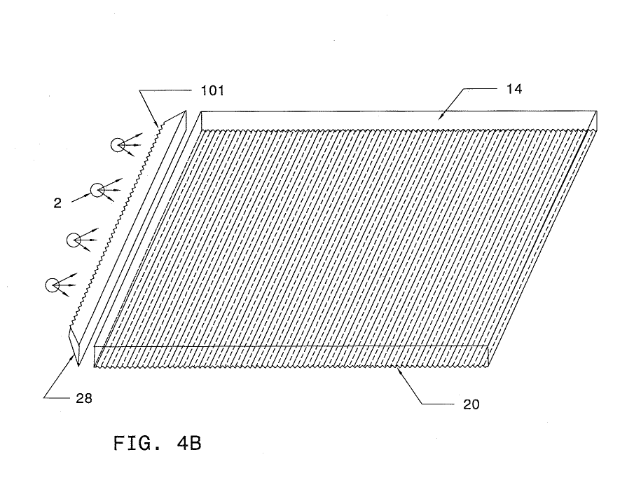

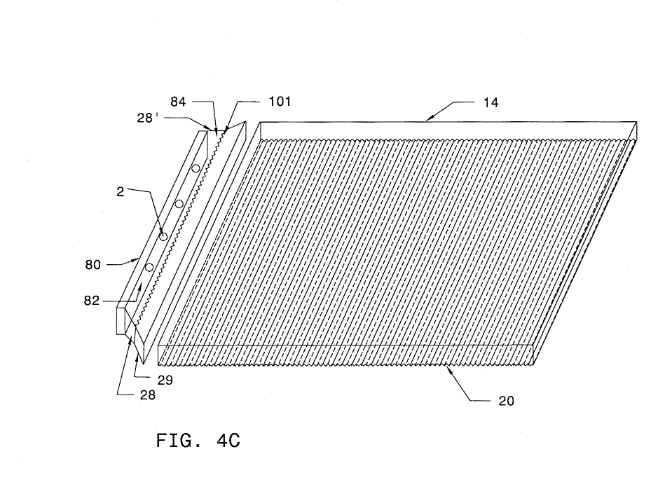

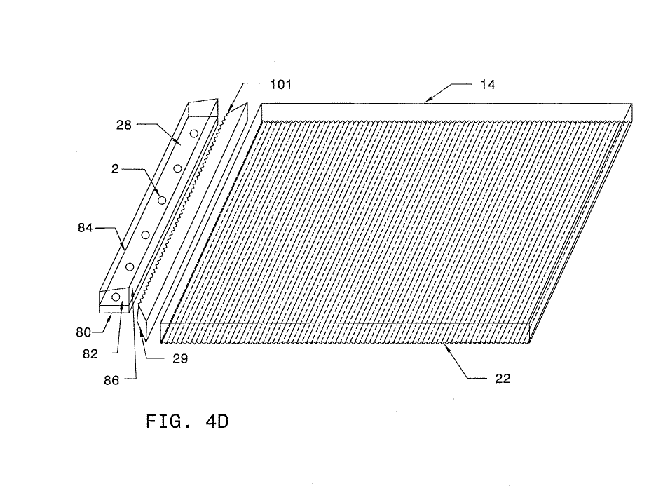

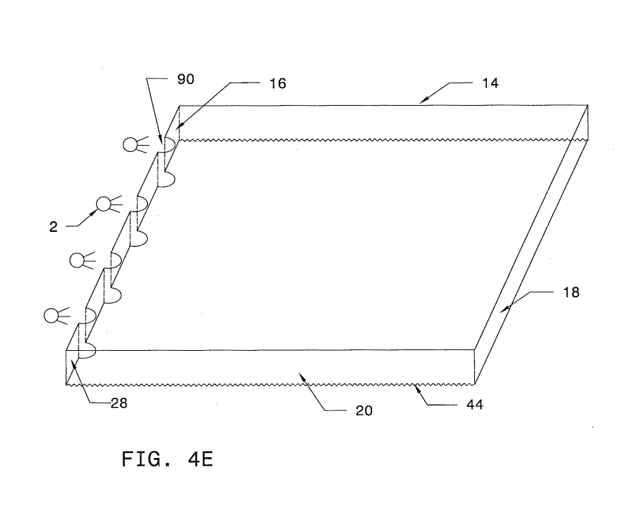

FIG. 4A shows another embodiment of this invention where the prismatic film 66 is placed between the light source 2 and the light collector 28. This arrangement also enhances the mixing of light beams in the output light. FIG. 4B shows another embodiment where the light collector 28 is made of a solid light transparent material, such as acrylic plastic, or glass, and the microprisms 101 (or microlenses) are located on the entrance side surface of the light collector 28. An arrangement can also be made to have the microprisms located on the exit surface of the light collector 28.

FIG. 4C shows another embodiment of this invention where two light collectors 28, 29 are used to achieve a very good uniformity. In this embodiment, the point like light sources 2, LEDs in this particular example, are located on a PC board 80. The first light collector 28 is formed by the surface of the PC board 82, the wall of a “tube” 84 that connects the PC board 80 to the second light collector 28. In this particular embodiment, the inside wall 84 of the first light collector 28 and the surface 82 of the PC board 80 (except the light emitting surface of LEDs 2) are reflective surfaces. The second light collector 29 is a solid light transmitting block with flat walls on all the sides except the side 101 facing the LEDs, which is a surface with microprisms. The air gap in the first light collector allows light beams from the LEDs to illuminate the light entrance surface 101 of the second light collector 29 uniformly. Prismatic structure 101 on the light entrance surface of the second light collector 29 expands light beams entering the second light collector 29, so that light entering the light guide will be uniformly mixed in color, and also achieve good uniformity in brightness. As is described above, the prismatic structure 101 may face the light pipe 14, instead of light collector 28.

FIG. 4D shows another embodiment of this invention where the light sources 2 are located on the bottom surface of the first light collector 28. The inside surfaces 84 of the first light collector 28, except the surface 86 facing the second light guide 29 and the light emitting surface of the light source 2, are reflecting surfaces. Light from the light sources 2 will be mixed in this light collector 28, before entering light collector 29 to provide uniform lighting.

FIG. 4E shows another embodiment where the light collector 28 is an integral part of the light pipe 14. The side surfaces of the light collector/light pipe 16 facing the point-like light sources 2 have curved sections 90, preferably conical concave, to expand light beams entering the light pipe 14.

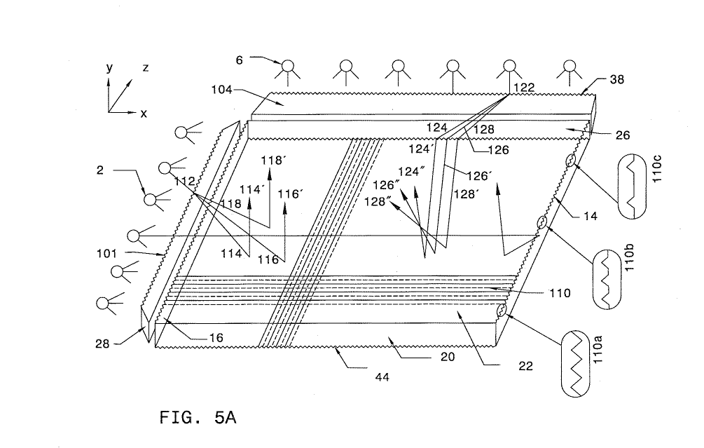

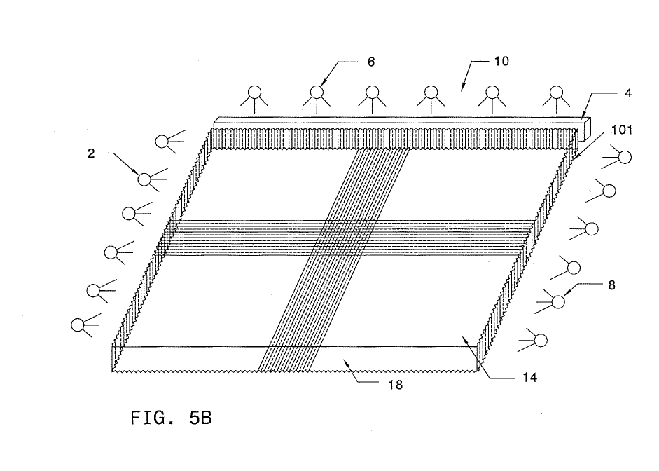

FIG. 5A shows another embodiment of this invention where the light pipe 14 has rows of microprisms 110 on its top surface 22 and microprisms 44 on its bottom surface 20. The axis of the microprisms 110 on the top surface is essentially perpendicular to that of the microprisms 44 on the bottom surface.

The embodiment shown in FIG. 5A has two light collectors 28, 38 facing two adjacent side surfaces 16, 26 of the light guide 14, and two rows of light sources 2 and 6. A light beam 112 from light source 2, entering the light guide from the side surface 16, will eventually incident on bottom surface 20 and associated microprisms 44 and be thus propagated mainly towards the y-direction and reflected out as beams 114′, 116′, 118′ by microprisms 44 on the bottom surface of the light pipe 14.

A light beam 122 entering the side surface 26 will propagate mainly in the -z-direction. As show in the drawing, beam 122 will then split into beams—shown as 124, 126,128—by the prismatic structure on the light collector 38. The beams will then be reflected downward by a prism 110 located on the top surface 22 of the light pipe 14. The reflected light beams, 124′, 126′, 128′, will incident on the bottom surface 20 of the light guide 14, and will be reflected out by the bottom surface of the light pipe as light beam 124″, 126″, and 128″. Here it should be noted that the beams 124, 126, 128 make small angles of incidence with the surfaces of the microprisms 110 so that they are reflected down by total internal reflection. The beams reflected back from the bottom surface 124″, 126″, 128″ have their angle changed, and therefore no longer satisfy the condition of total internal reflection. The reflected back beams 124″, 126″, 128″ will therefore pass through the top surface 22 of the light pipe to provide display lighting. Light beams entering the light pipe 14 from the two surfaces 16 and 26 will therefore provide independent lighting, and light from the two sets of the light sources 2 and 6 can each provide uniform illumination. It can therefore achieve a dual mode operation.

A light pipe with rows of microprisms on both surfaces is discussed in detail in U.S. Pat. No. 5,854,872. For light beam 116, microprisms on the top surface 22 of the light pipe works as a divergent angle rotator. For light beam 122, microprisms on the bottom surface 20 of the light pipe works as a divergent angle rotator. The density of the microprisms 110 on the top surface 22 of the current embodiment varies as a function of the distance from the light source to provide uniform lighting for light beams comes from the side surface 26. The increase in the density of the prisms (reducing the distance between microprisms) at areas away from the light source is made to compensate for the reduction in the intensity of light beams inside the light pipe at that area, thereby giving more uniform lighting over the lighting area. In the backlight discussed in U.S. Pat. No. 5,854,872, prisms 110 on the top surface 22 are uniformly distributed to reduce the divergent angle of the light beam in the y-z plane. With a uniform prism distribution on the top surface 22, output light for light entering the side surface 26 will not be uniform.

FIG. 5B shows an embodiment that allows light entering the light pipe 14 from three sides. It is trivial to extend this embodiment to a light guide that has light entering the light pipe from all four sides. In this drawing, a color filter 4, which blocks long wavelength red and infrared light, is placed between the light source 6 and the light pipe 14 to make the backlight suitable for night vision applications. This backlight system can therefore achieve day mode, and night vision mode operation with the use of a single light pipe. Light in the two modes will have different spectrum. The light pipe 14 in FIG. 5B has microprisms 101 on the three light entering side surfaces. The fourth side surface 18 of the light pipe is a white or specular reflective surface. In FIG. 5B, the light collectors are integral parts of the light guide 14, which now has microprisms on the three light entering side surfaces.

The light pipe 14 for the dual mode backlight in the embodiment shown in FIG. 5A and FIG. 5B includes microprisms 44 on the bottom surface 20 to reflect light out of the light pipe 14. It is not necessary, however, to have microprismatic structures on the bottom surface 20 of the light guide in order to have the dual mode operation described in this invention. Instead, a light guide with structures on the bottom surface 20, such as dot matrix to scatter light, will also work as a dual mode backlight if the top surface 22 has the micro prismatic structure 110 described in this invention. Physically, the structure 110 on the top surface 22 of the light pipe 14 provides a second degree of freedom in the design of the light pipe 14 in order to allow two independent modes of operation. The microprisms 110 on the top surface 20 of the light pipe 14 can also be replaced by micro-grooves, or any other microstructure that has a surface adapted to reflect light by specular reflection, to achieve the dual mode operation.

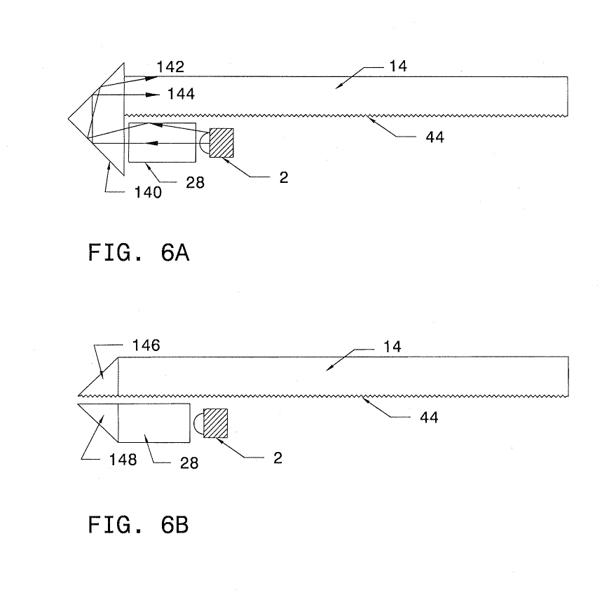

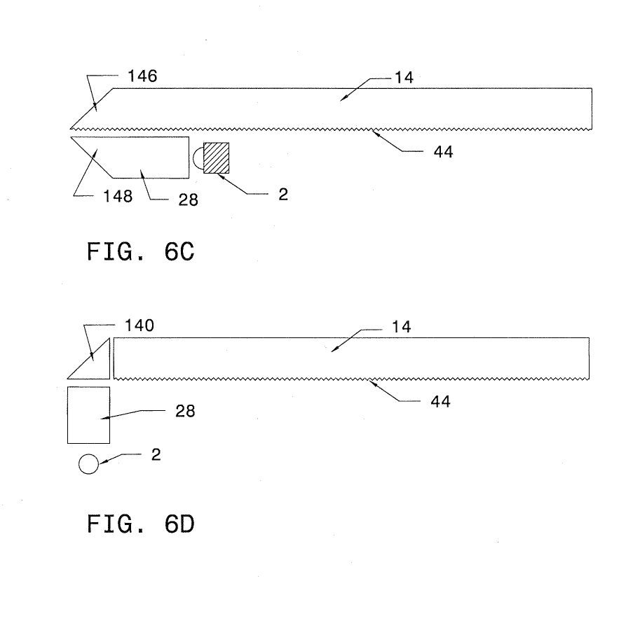

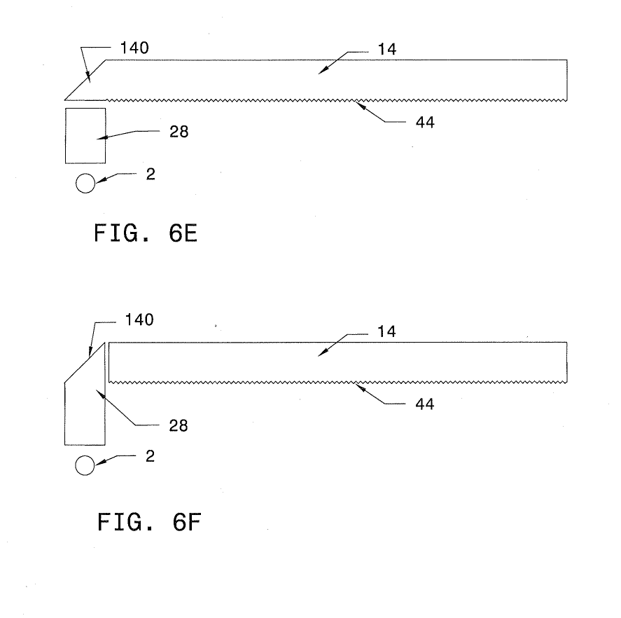

The light collector arrangement described above will enhance the mixing of light beams coming from point-like light sources. However, they also increase the size of the display in the y-z plane. A display with a significantly increased size in the y-z plane may not be applicable for certain applications, such as instrument backlighting in an airplane. To reduce the size of the backlight system in the y-z plane, one may use a prism to bend the light beams so that the light source 2 and the light collector 18 can be placed underneath the display. In the embodiment shown in FIG. 6A, light beams 142, 144 output from the light source 2, are collected by the light collector 28, enter a prism 140, and make two right angle reflections to enter the lighting light pipe 14. FIG. 6B shows an embodiment wherein the prism 140 is replaced by two smaller prisms 146, 148. FIG. 6C shows another embodiment that the two smaller prisms 146, 148 are each combined and become an integral part of the lighting light pipe 14, and the light collector 28 respectively.

FIG. 6D shows another method of using a prism to have the point-like light sources 2 and the light collector 28 placed underneath the lighting light pipe 14 and directly underneath prism 140. FIG. 6E and FIG. 6F show a similar arrangement to FIG. 6D but with prism 140 being an integral part of the light pipe 14, and the light collector 28, respectively.

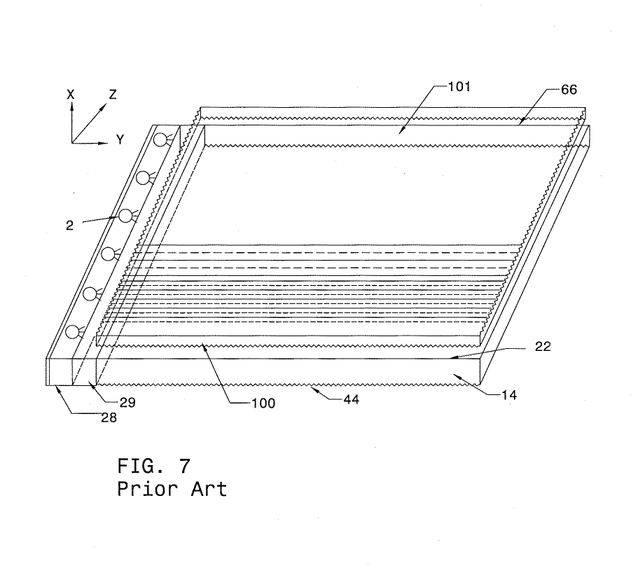

FIG. 7 shows yet anther embodiment of this invention. In this embodiment, the prismatic diffuser 66 is located on top of the light emitting surface 22 of the light pipe 14. The method of using a prismatic film on top of a light pipe to change the propagation direction of output light beams from a microprism based backlight system is described in U.S. Pat. No. 5,926,601. For backlight using point-like light sources, this method also improves the “mixing” of light beams coming from different point-like light sources by changing the propagation direction of, and expand, the light beams. To enhance light mixing, the prismatic diffuser demonstrated in FIG. 7 has prismatic structure on both sides of its surface. The diffuser 66 is also made to have certain thickness to become a “prismatic diffuser plate”.

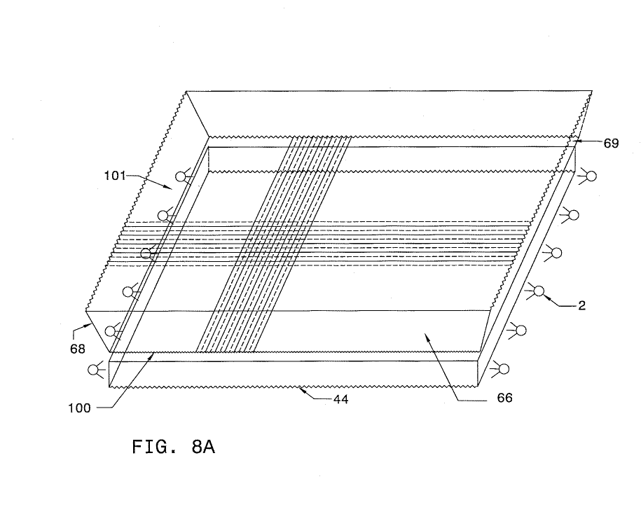

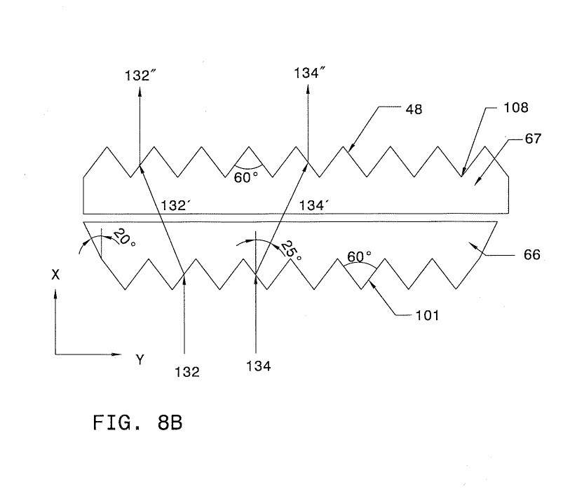

FIG. 8A shows another embodiment of this invention where the prismatic diffuser plate 66, placed on top of the light pipe 14, has tilted side surfaces 68, 69. This prismatic diffuser 66 with the tilted side surfaces is made to increase the effective viewing area of the backlight, in addition to enhance the mixing of light beams coming from different light sources. With this invention, the light source can be hid underneath the tilted side surfaces 68, 69 to make the viewing area of the backlight system extend from edge to edge of the backlight system. The prismatic diffuser 66 with tilted side surfaces can therefore be called a viewing area expander. A second prismatic film, shown as 67 in FIG. 8B, can be placed on top of the viewing area expander 66 to re-focus light in the forward direction. This prismatic film 67 has rows of prisms with an angle of 60 degree between the two adjacent surfaces. The prismatic film 67 may also have rows of prisms with other angles, such as 90° between the two adjacent surfaces, as found in the Backlight Enhancement Film provided by 3M.

FIG. 8B is a sectional view, taken through a section in the x-y plane, of light beams 132 134 propagation through this viewing area expanding plate. In this particular example, the two walls of the viewing area expander, the prismatic plate, perpendicular to the y-z plane are now tilted by 20° from the x-z plane. It is also assumed that the prisms on the bottom surface of the viewing area expander have rows of microprisms with surfaces making an angle of 60° with each other. We further assume that the output light from the light pipe propagates in a direction perpendicular to its surface 101. Assuming the viewing area expander is made of acrylic, which has an index of light refraction of 1.49, light beams entering the expander will now be split into two beams propagating side ways with an angle of ±25 degree. Some of the light beams inside the expander will now reach the area above the inclined surface. Light beams output from this expander will propagate at ±39° towards another prismatic film, which also has 60° microprisms 48 on its top surface 108. With the surfaces of the microprisms on the prismatic film also makes an angle of 60° with each other, output light 132″, 134″ from the top prismatic film will now propagate in the normal direction, the propagation direction of the original beam 132, 134. The viewing area of backlight is therefore expanded by the prismatic plate 66. The increase in the viewing area is proportional to the thickness of the prismatic plate 66. Here it should be noticed that the side surface of microprisms in the expander may be curved surfaces, to give a more uniform output light distribution. Prisms on the film 67 may also have an angle, such as 90°, different from that of the microprisms in the viewing area expander.

Having described and illustrated the principles of the invention in a preferred embodiment thereof, it should be apparent that the invention can be modified in arrangement and detail without departing from such principles. We claim all modifications and variation coming within the spirit and scope of the following claims.

What is claimed is:

1. A light expanding system for producing collimated light for a display from point-like light sources, comprising:
(a) a light pipe having first, second, and third surfaces, wherein:
the first and the second surfaces are substantially perpendicular; and
the third surface is opposite the second surface; and
(b) a plurality of microprisms positioned adjacent to the second surface of the light pipe, each microprism comprising:
a base surface that is adjacent and substantially parallel to the second surface of the light pipe; and
a light reflecting surface shaped so that light that entering the light pipe and contacting the light reflecting surface is reflected away from the microprism out of the light pipe through the third surface.

2. An assembly according to claim 1, further including means to mix light beams coming from different point-like light sources in a predetermined manner to provide uniform lighting.

3. An assembly according to claim 2, wherein said means to mix light beams coming from different point-like light source comprises a plurality of microstructures adapted to one dimensionally increase the divergent angle of light beams passing through the microstructures.

4. An assembly according to claim 3, wherein said microstructures are microlenses.

5. An assembly according to claim 3, wherein said microstructures are microgrooves.

6. An assembly according to claim 3, wherein said microstructures are elements of a hologram.

7. An assembly according to claim 3, wherein at least one of said microstructures is immediately adjacent to a light collector positioned between the point-like light sources and the light pipe, the one microstructure further comprising:
a base surface that is positioned adjacent to a light exit surface of the light collector; and
a light refraction surface with at least a section that is not parallel to the base surface.

8. An assembly according to claim 3, wherein at least one of said microstructures is immediately adjacent to the first surface of the light pipe, the one microstructure further comprising:
a base surface that is positioned adjacent to a light entrance surface of the light collector; and
a light refraction surface with at least a section that is not parallel to the base surface.

9. An assembly according to claim 2, wherein the said means to mix light beams coming from different point-like light sources comprise a beam collector having a light refraction surface with at least a section that is curved.

10. An assembly according to claim 9, wherein said beam collector is an integral part of the said light guide.

11. An assembly according to claim 1, further including a prism positioned between the light source and the light pipe and adapted to change the propagation direction of light beams entering the light pipe.

12. An assembly according to claim 3, wherein at least one of said plurality of microstructures is immediately adjacent to a plate positioned between said light pipe and the display.

13. An assembly according to claim 12, wherein said plate also includes side surfaces, and at least one of the side surfaces is tilted, so that a light output surface is larger than a light entrance surface of the plate.

14. An assembly according to claim 1, wherein said light pipe includes:
a fourth surface that is substantially perpendicular to the third surface; and
a plurality of microprisms positioned immediately adjacent to the third surface, wherein an axis of the microprisms on the third surface is substantially perpendicular to an axis of the said microprisms on the second surface.

15. A light system adapted to use one light guide to produce dual mode display lighting with light from two independent light sources, comprising:
(a) means for producing light independently from two light sources comprising a first light source and a second light source;
(b) a light pipe having first, second, third, and fourth surfaces, wherein:
the first and the second surfaces are substantially perpendicular;
the third surface is opposite the second surface; and
the fourth surface is substantially perpendicular to the third surface; and
(c) an optical arrangement configured so that light from the first light source is adapted to enter the light pipe from first surface of the light pipe, and exit the light pipe from the third surface, and
(d) a continued optical arrangement configured so that light from the second light source is adapted to enter the light pipe from the fourth surface and exit the light pipe from the third surface.

16. A light system as described in claim 15, further including:
(a) a plurality of microstructures positioned immediately adjacent to the third surface of the light pipe, each microstructure comprising:
a base surface that is adjacent and substantially parallel to the third surface of the light pipe; and
a light reflecting surface shaped so that light entering the light pipe and contacting the light reflecting surface is reflected away by specular reflection from the reflecting surface towards the second surface.
(b) a reflector positioned adjacent to the second surface to reflect light out of the light pipe through the second and the third surface.

17. A light system as described in claim 15 wherein a plurality of microstructures are positioned immediately adjacent to the second surface of the said light pipe, each microstructure comprising:
a base surface that is adjacent and substantially parallel to the second surface of the light pipe; and
a light reflecting surface shaped so that light that enters the light pipe and contacts the light reflecting surface is reflected away from the microstructure out of the light pipe through the third surface.

18. A light system according to claim 15, wherein said first light source is a combination of point-like light sources.

19. A light system according to claim 18, further including means for mixing light beams originating from said point-like light sources of the first light source in a predetermined manner to provide uniform lighting for light beams from said first light source entering said light pipe.

20. A light system according to claim 19, wherein said means for mixing light beams coming from said point-like light sources comprises a plurality of microstructures adapted to one dimensionally increase the divergent angle of light beams passing through the microstructures.

21. A light system according to claim 20, wherein said microstructures are microlenses.

22. A light system according to claim 20, wherein said microstructures are microgrooves.

23. A light system according to claim 20, wherein said microstructures are elements of a hologram.

24. A light system according to claim 20, wherein at least one of said microstructures is immediately adjacent to a light collector positioned between a point-like light source and the light pipe, the one microstructure further comprising:
a base surface that is positioned adjacent to a light entrance surface of the light collector; and
a light refraction surface with at least a section that is not parallel to the base surface.

25. A light system according to claim 20, wherein at least one of said microstructures is immediately adjacent to a light collector positioned between a point-like light source and the light pipe, the one microstructure further comprising:
a base surface that is positioned adjacent to a light exit surface of the light collector; and
a light refraction surface with at least a section that is not parallel to the base surface.

26. A light system according to claim 20, wherein at least one of said microstructures is immediately adjacent to said first surface of the light pipe, the one microstructure further comprising:
a base surface that is positioned adjacent to the light entrance surface of the light collector; and
a light refraction surface with at least a section that is not parallel to the base surface.

27. A light system according to claim 20, wherein said plurality of microstructures is immediately adjacent to a plate positioned between the said light pipe and the display.

28. A light system according to claim 27, wherein said plate includes side surfaces, and at least one of the side surfaces is tilted, so that a light output surface is larger than a light entrance surface of the plate.
